(19) United States
(12) Patent Application Publication
(10) Pub. No.: US 2025/0187185 A1
(43) Pub. Date: Jun. 12, 2025

(54) DEVICE FOR GENERATING SEARCH PROGRAM FOR ROBOT

(71) Applicant: Fanuc Corporation, Minamitsuru-gun, Yamanashi (JP)

(72) Inventors: Tomohiro FURUTA, Minamitsuru-gun, Yamanashi (JP); Shigeo YOSHIDA, Minamitsuru-gun, Yamanashi (JP); Kiichi TERAMOTO, Minamitsuru-gun, Yamanashi (JP)

(73) Assignee: Fanuc Corporation, Minamitsuru-gun, Yamanashi (JP)

(21) Appl. No.: 18/840,146

(22) PCT Filed: Mar. 7, 2022
(86) PCT No.: PCT/JP2022/009814

§ 371 Date: Aug. 21, 2024

(51) Int. Cl. B25J 9/16

(52) U.S. Cl. CPC B25J 9/1661

(57) ABSTRACT

Provided is a program-generating device that makes it possible to greatly simplify the work of a user in creating a search program for generating teaching points. The program-generating device includes a reception unit that receives input of a search start position and a search end position on a work line according to a sensor, and input of information about a search program including the detection conditions of the sensor; and a program-generating unit that generates, on the basis of the content received by the reception unit, a search program for setting teaching points corresponding to the positions on the work line.

### CROSS REFERENCE TO RELATED APPLICATIONS

This is the U.S. National Phase application of PCT/JP2022/009814 filed Mar. 7, 2022, the disclosure of this application being incorporated herein by reference in its entirety for all purposes.

### FIELD OF THE INVENTION

The present invention relates to a program generation device for generating a search program for a robot.

### BACKGROUND OF THE INVENTION

A robot system including a robot, a work tool such as a welding torch attached to the robot, and a controller for controlling the robot is well known. The controller drives the robot and the work tool based on an operation program, and a user of the robot can teach teaching points in advance to determine the position and posture of the robot during an operation. The operation program is generated based on the positions of the teaching points.

The location of the teaching point can have a significant effect on the quality of the operation performed by the robot. For example, in a robot system for performing arc welding, the robot moves a welding torch attached to a robot arm, etc., along an operation path determined based on the teaching points. When the operation path deviates from a desired path, a welding line also deviates from the desired path, resulting in a decrease in processing accuracy.

In order to correct such a deviation in the operation path, a control method is known in which a sensor is provided to a work tool such as a welding torch, and the operation path is corrected while performing an operation such as welding. For example, a control method is known in which an operation path is previously generated by specifying start and end points, and then, while the position of the robot is moved along the operation path, the position where the welding is to be performed detected by the sensor is set as a teaching point (e.g., see Patent Literature 1).

Also, a robot, configured to detect the position of a welding line using a laser sensor and simultaneously move a work tool along the detected line to perform an operation such as welding, is well known (e.g., see Patent Literature 2).

### PATENT LITERATURE

[PTL 1] JP 1995(H07)-104831 A
[PTL 2] JP 2001-129776 A

### SUMMARY OF THE INVENTION

In order to effectively suppress the positional deviation of the operation path of the robot, it is desirable to accurately generate and set the teaching point. For example, the teaching point can be set by the operator manually moving the robot to a desired position and posture, but the teaching point often requires high accuracy of 1 mm or less. Therefore, the operator needs to have high skills, and even for experienced operators, a lot of work time may be required.

One way to generate a teaching point is to set a search point to determine the next teaching point along the operation path based on a certain teaching point. However, since it is difficult for the user to visually recognize the search point, unexpected movement of the robot may occur. Further, the position of the search point must be calculated repeatedly, and as a result, it may take time to generate the teaching point. Furthermore, it may be necessary to perform teaching at the teaching point and/or the search starting point, etc., and the user needs skill to perform precise teaching by operating a jog, etc.

One aspect of the present disclosure provides a program generation device configured to generate a program for controlling a robot having a sensor capable of detecting an operation line of a workpiece, the program generation device comprising: a reception unit configured to receive an input of a search start position and a search end position of the operation line by the sensor, and an input of information relating to a search program including a detection condition of the sensor; and a program generation unit configured to generate a search program for determining a teaching point corresponding to a position of the operation line, based on contents received by the reception unit.

Another aspect of the present disclosure provides a program generation device configured to generate a program for controlling a robot having a sensor capable of detecting an operation line of a workpiece, the program generation device comprising: a display unit capable of displaying the program; a display control unit to cause a wizard to be displayed on the display unit, the wizard being configured to receive an input of a search start position and a search end position of the operation line by the sensor, and an input of information relating to a search program including a detection condition of the sensor; and a program generation unit configured to generate a search program for determining a teaching point corresponding to a position of the operation line, based on contents received by the wizard.

According to the present disclosure, the operation of the user in generating the search program is greatly simplified by the input via the reception unit, and thus the user can easily and quickly generate the search program for generating the teaching points.

### BRIEF DESCRIPTION OF DRAWINGS

FIG. 1 is a schematic configuration view of a robot system according to an embodiment.

FIG. 2 is a view schematically showing a welding operation by a robot.

FIG. 3 is a view showing an example in which a search start point is taught by using a user interface.

FIG. 4 is a view showing an example in which a search end point is taught by using the user interface.

FIG. 5 is a view showing an example in which a welding program is executed by using the user interface.

FIG. 6 is a view showing an example in which an operation program is automatically generated by using the user interface.

FIG. 7 is a view showing another example in which the search point is taught by using the user interface.

FIG. 8 is a view exemplifying a wizard displayed on the user interface in the example of FIG. 7.

FIG. 9 is a flowchart showing an example of a process in a program generation device.

### DETAILED DESCRIPTION OF EMBODIMENTS OF THE INVENTION

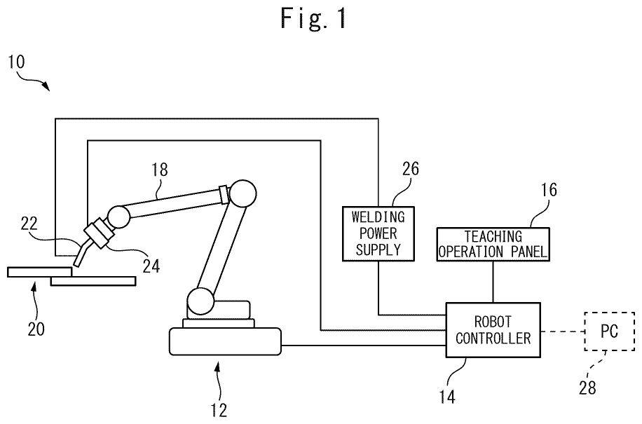

FIG. 1 is a schematic configuration view of a robot system according to a preferred embodiment. The robot system 10 includes at least one robot 12, a robot controller 14 configured to control the robot 12, and a teaching operation panel 16 communicably connected to the robot controller 14 by wireless or wire.

The robot 12 is, for example, an industrial articulated robot, and has a movable part (robot arm) 18, a work tool 22 attached to a front end of the movable part 18 and configured to perform a predetermined operation on an work object (workpiece) 20, and a sensor 24 capable of detecting a position of a work site (e.g., an operation line) on the workpiece 20 by the work tool 22. In this embodiment, the work tool 22 is a welding torch, and accordingly, the robot system 10 includes a welding power supply 26 for supplying current to the welding torch 22 based on a command from the robot controller 14. As described above, in this embodiment, the operation line includes the welding part of the workpiece, although the present disclosure is not limited as such. For example, the predetermined operation to be performed by the robot may be sealing, the operation line may include a sealing part of the workpiece, and the working tool 22 may be a nozzle for dispensing adhesive.

In the embodiment, the sensor 24 is a laser scanner type 3D sensor (laser sensor) having an emission unit configured to emit light (e.g., laser beam) based on a command from the robot controller 14, and an image sensor (CCD, CMOS, etc.) configured to receive the light reflected by the workpiece and convert it to electricity. The sensor 24 is attached to the front end of the movable part 18 or the welding torch 22 using an appropriate fixture (not shown), and can search the operation line by continuously scanning the workpiece along the operation line. However, the sensor is not limited to a laser sensor, and any sensor capable of detecting the operation line can be used. For example, a 3D sensor can also be used. Examples of the 3D sensor may include a TOF (Time of Flight) camera configured to capture a distance image using a time-of-flight method, or a stereo camera configured to detect a 3D position based on a parallax captured by two 2D cameras, etc.

The robot 12 is configured to be able to perform various processes and/or operations such as welding based on a command transmitted from the robot controller 14. The robot controller 14 includes a processor and a storage unit (memory, etc.), and can control the robot 12 based on an operation program described below. In addition to the operation program for controlling the robot 12, the robot controller 14 can generate and save a search program, which will be described later, and execute it to control the sensor 24. In other words, in this embodiment, the processor of the robot controller 14 has functions of a display control unit and a program generation unit. However, the present disclosure is not limited as such, for example, a computer such as a personal computer (PC) 28 connected to the controller 14 by wire or wirelessly and having a processor and a storage unit (memory, etc.) may generate each program, so that the generated program can be transmitted from the PC 28 to the controller 14.

The teaching operation panel 16 includes a reception unit such as a keyboard or a touch panel capable of receiving various inputs from the user, and a display unit such as a display. The reception unit and the display unit constitute a user interface described below.

### FIRST EXAMPLE

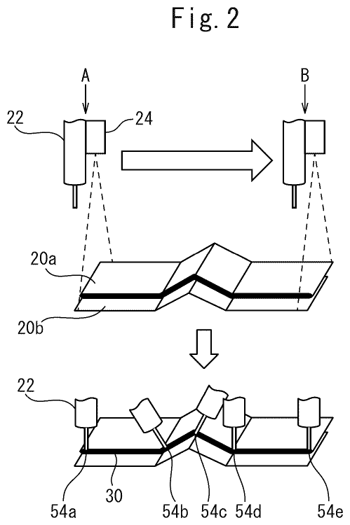

FIG. 2 is a view schematically illustrating welding as an example of an operation performed by the robot 12. In this regard, the shapes of two plate-shaped workpieces 20a and 20b having ups and downs are measured using the laser sensor 24 attached to the welding torch 22, and teaching points are automatically generated based on information obtained from the sensor 24. Then, arc welding is performed along a welding line 30.

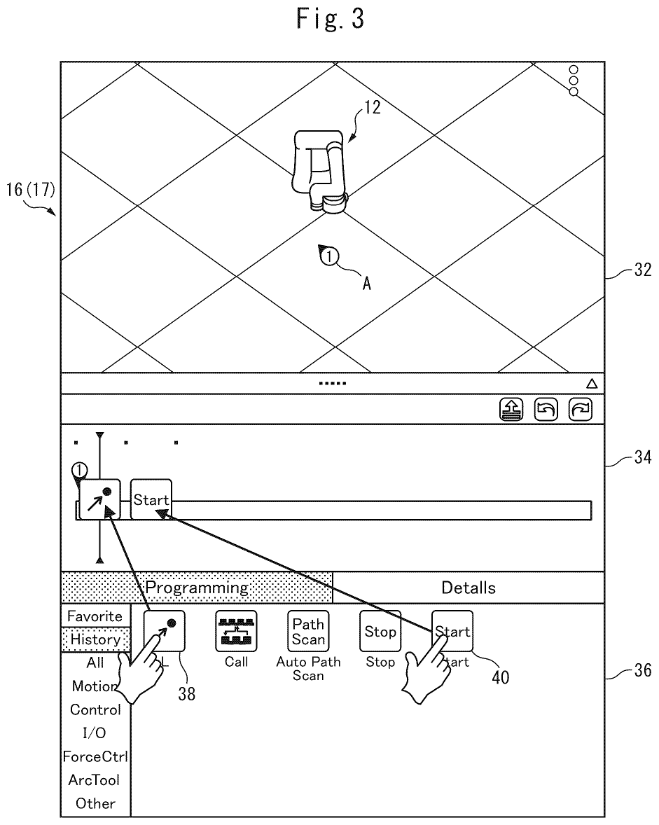

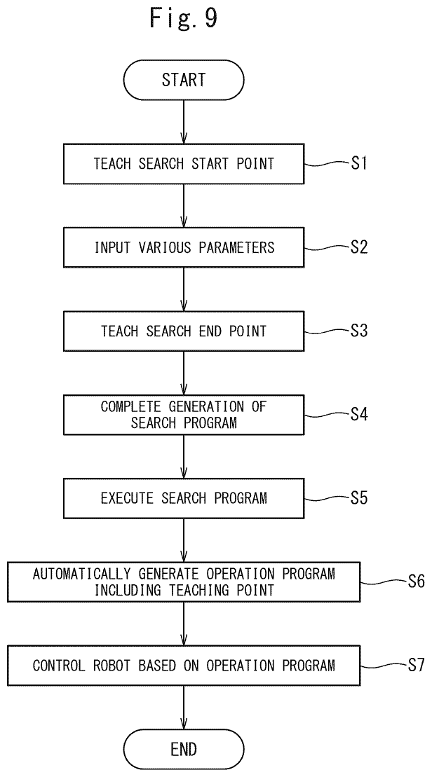

Hereinafter, means and procedures for generating a search program and an operation program will be described with reference to a user interface shown in FIGS. 3 to 6 and a flowchart shown in FIG. 9. In this embodiment, the user or operator of the robot 12 (hereinafter simply referred to as the user), can input various information for generating the search program and the operation program as described later, via a user interface (UI) 17 displayed on the display of the teaching operation panel 16, etc. In other words, the UI 17 has the functions of the display unit which allows the user to visually recognize various information, and the reception unit which receives various inputs from the user. The UI 17 includes a robot display area 32 capable of displaying a robot image corresponding to the position and posture of the actual robot 12, a timeline display area 34 capable of displaying icons (described later) arranged in chronological order, and a menu area 36 capable of displaying each icon so that the user can select a desired icon.

First, in step S1, the user of the robot 12 teaches a search start position (search start point) for the robot 12. Specifically, the user moves the robot 12 so that the sensor is positioned at a search start point A (see FIG. 2) where the sensor 24 can detect the welding start position or its vicinity. In this regard, in the robot display area 32, an image corresponding to the position and posture of the actual robot 12 moved by the user can be displayed. After confirming that the robot 12 is positioned at the search start point A, the user selects the icon 38 (L) representing the search point from the menu display area 36, and moves the selected icon to the timeline display area 34 by an operation such as drag and drop. Then, the icon “L” is placed at the left end of the timeline display area 34, which means that the search start position has been taught.

In this regard, the search start position is different from the welding start position (operation start position). For example, in direct teaching, it may be difficult to teach the welding start position due to interference between the robot and the workpiece. In such a case, the teaching can be facilitated by using the search start position which is some distance from the welding start position. However, when there are no restrictions such as interference, the search start position and the welding start position may end up being the same position. Similarly, the search end position is different from the welding end position (operation end position), but may end up being the same position.

Next, the user selects an icon 40 (Start) representing a search start command from the menu display area 36, and moves the icon to the timeline display area 34 by an operation such as drag and drop. Then, the icon “Start” is placed to the right of the icon “L” in the timeline display area 34.

By the search start command, the user can set various parameters in the search program (step S2). For example, the search program may include at least one of information relating to the search range of the sensor 24, information relating to the output of the sensor 24, information relating to the path of the sensor 24, and information relating to the automatically generated operation program. For example, the user can input an interval between each teaching point as the information relating to the path of the sensor 24. Also, the user can input information relating to the automatically generated operation program, e.g., can specify a torch angle and/or a welding speed in the operation program.

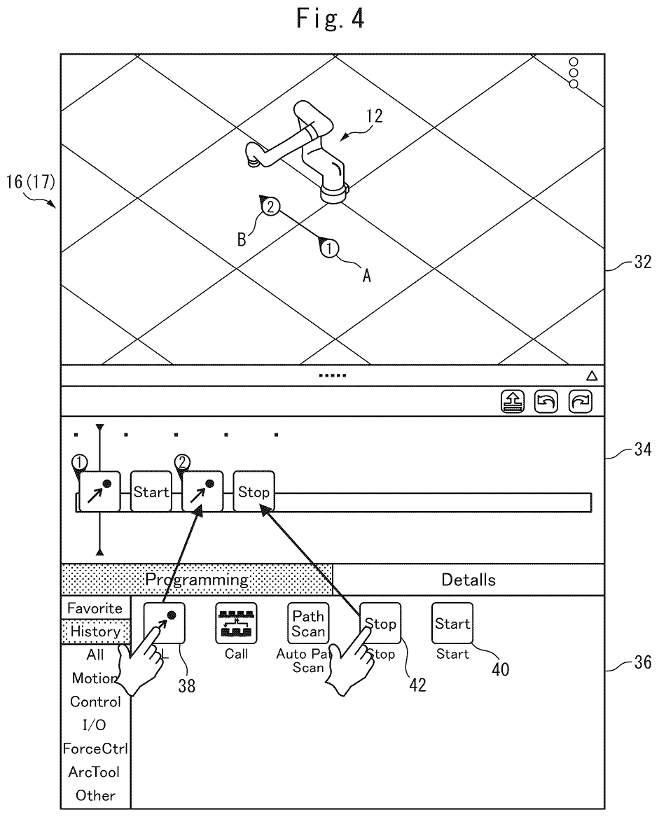

Next, as shown in FIG. 4, the user of the robot 12 teaches the search end position (search end point) for the robot 12 (step S3). Specifically, the user moves the robot 12 so that the sensor 24 is positioned at a search start point B (see FIG. 2) where the sensor 24 can detect the welding end position or its vicinity. In this regard, the robot display area 32 displays the state of the actual robot 12 moved by the user. After confirming that the robot 12 is positioned at the search end point B, the user selects the icon 38 (L) representing the teaching point from the menu display area 36 and moves the selected icon to the timeline display area 34 by the operation such as drag and drop. Then, an icon “L” is placed to the right of the icon “Start” in the timeline display area 34, which means that the search end position has been taught.

Next, the user selects an icon 42 (Stop) representing that the search has been completed from the menu display area 36, and moves it to the timeline display area 34 by the operation such as drag and drop. Then, an icon “Stop” is placed at the right end of the timeline display area 34.

After the processes of S1 to S3 are completed, the robot controller 14 or the PC 28, which corresponds to the program generation unit, completes the generation of the search program for performing the search using the sensor 24 (step S4). In other words, the search program can be displayed as a series of icons arranged and displayed in chronological order within the timeline display area 34. In this way, the user can generate the search program through visually and intuitively easy-to-understand operations via the teaching operation panel (UI). Therefore, even when the user is not an expert, he or she can generate the desired search program in a short time with simple operations. In this embodiment, the user teaches the search start point and search end point by directly moving the robot with his or her hand (so-called direct teaching). However, the present disclosure is not limited as such, for example, the user may move the robot by jog operation.

Further, in the search program, the user can add not only the search start point and the search end point, but also any arbitrary point. For example, for the purpose of changing the movement direction of the torch during laser irradiation, at least one intermediate point can be taught between the search start point and the search end point. Furthermore, the operation mode of the torch is not limited to a straight line, and the torch can be operated along an arc, for example. Information relating to these intermediate points can also be displayed as icons.

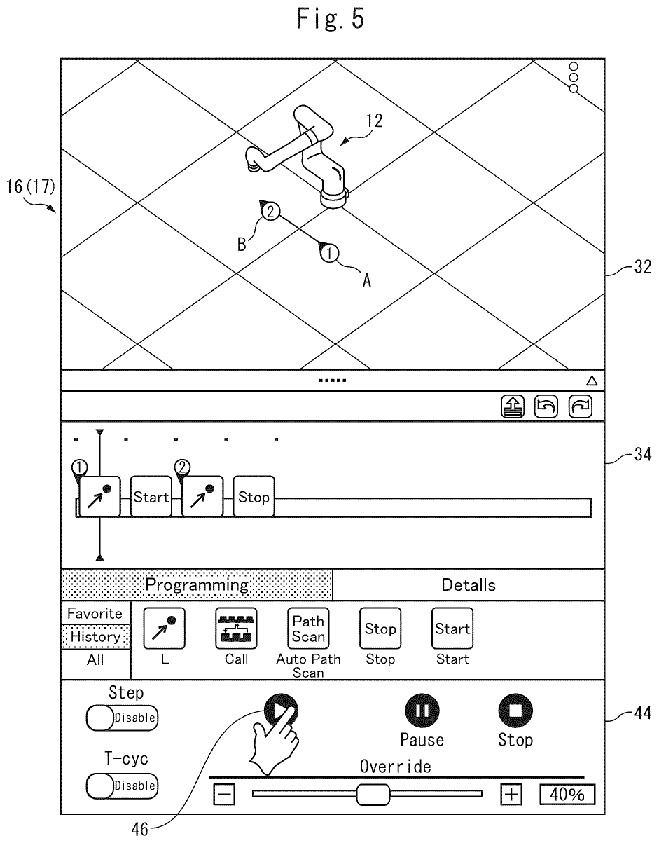

Next, the search program generated in step S4 is executed (step S5). Here, the scanning laser is irradiated from the sensor 24 toward the workpiece in a section from the search start position to the search end position, and at least one teaching point is generated in the same section. By virtue of this, an operation program including the teaching point is automatically generated (step S6). For example, as shown in FIG. 5, after the search program is generated, a program execution menu 44 is displayed, and when the user touches a program execution button 46 of the execution menu 44, the robot 12 starts a search operation based on the search program.

In the search operation, as shown in FIG. 2, while the sensor 24 moves from the search start position A to the search end position B, the shapes of the workpieces 20a and 20b are detected, and the teaching point of the robot 12 is automatically generated based on this result. In this example, since the workpiece has a raised portion near the center, a laser irradiation start point 54a corresponding to the starting end of the welding line 30, a laser irradiation end point 54e corresponding to the terminal end of the welding line 30, and intermediate teaching points 54b to 54d between the points 54a and 54e are generated. More specifically, the teaching points 54b and 54d correspond to the bottom of the raised portion, and teaching point 54c corresponds to the top of the raised portion.

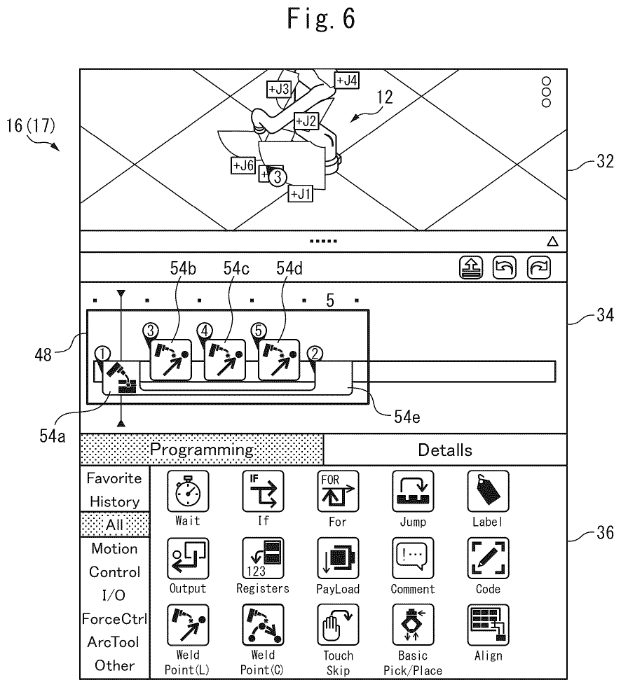

After the search is completed and the teaching point is generated, the operation program including the generated teaching point is automatically generated. For example, as shown in FIG. 6, the operation program is displayed in the timeline display area 34 as a combination of icons 48. In this regard, the operation program 48 includes an icon 54a representing the start of welding, an icon 54e representing the end of welding, and icons 54b to 54d representing each teaching point in the welding operation between the icons 54a and 54e. These icons are displayed in chronological order within the timeline display area 34. In the example of FIG. 6, although all of the icons 54a to 54e are displayed, at least one of the icon 54a including information relating to the search start position, the icon 54e including information relating to the search end position, and the icons 54b to 54d including information relating to the intermediate points between the search start position and the search end position, may be displayed.

The user can check and edit the automatically generated operation program through the UI 17 of the teaching operation panel 16. For example, by clicking any of the icons 54a to 54e in the timeline display area 34, various icons including work information etc., are displayed in the menu display area 36. Then, the user can set or change various parameters in the operation program, e.g., can correct the position of the teaching point, etc.

After the generation (and editing as necessary) of the operation program is completed, the robot is controlled based on the operation program (step S7). By virtue of this, the robot can perform a predetermined operation such as welding based on the automatically generated operation program.

### SECOND EXAMPLE

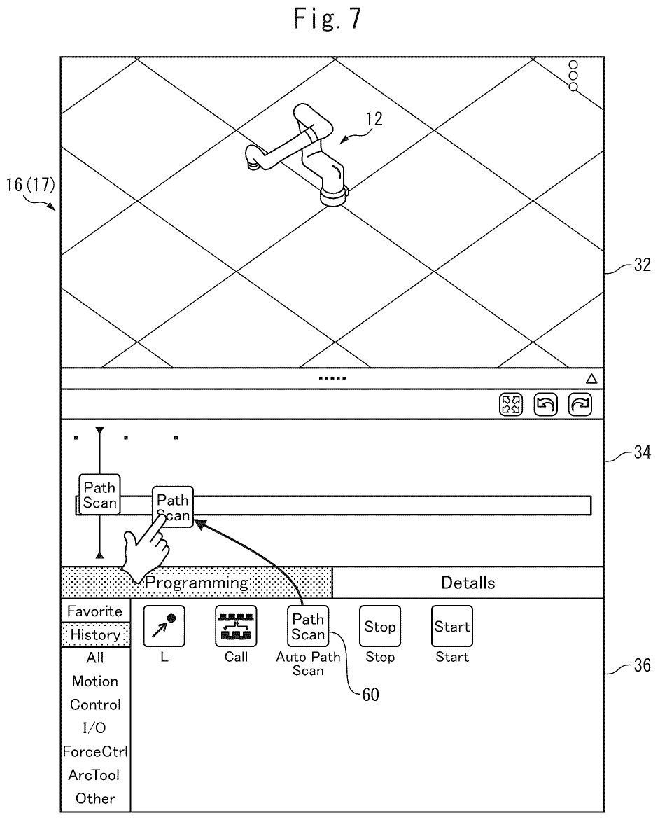

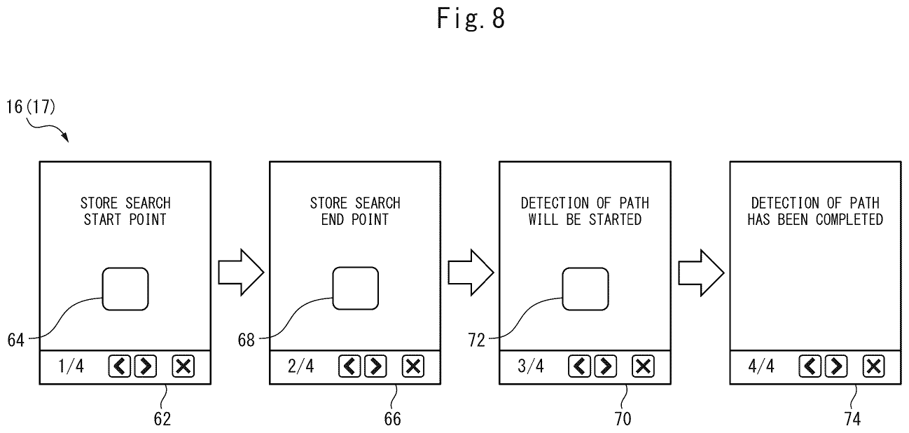

FIGS. 7 and 8 show another example of the UI for generating the search program. In the second example, only the parts different from the first example will be explained, and the explanation of the parts which may be the same as the first example will be omitted.

FIG. 7 shows an example of the UI displayed on the teaching operation panel 16. First, the user selects a path teaching icon 60 (Auto Path Scan) displayed in the menu display area 36, and moves the selected icon to the timeline display area 34 by the operation such as drag and drop. Then, an icon “Auto Path Scan” is placed at the left end of the timeline display area 34, and a wizard for setting a search path as illustrated in FIG. 8 is displayed at an appropriate location on the UI 17 of the teaching operation panel 16.

In the search path setting wizard, first, as shown by reference numeral 62, a screen prompting the user to store the search start point is displayed. In response to this, the user moves the robot 12 to the search start point A as in the first example, and taps a storage start button 64. By virtue of this, information on the search start point A is stored in the memory of the controller 14, etc.

Next, as shown by reference numeral 66, a screen prompting the user to store the search end point is displayed. In response to this, the user moves the robot 12 to the search start point B as in the first example, and taps a storage start button 68. By virtue of this, information on the search end point B is stored in the memory of the controller 14, etc., and a search program substantially similar to that shown in FIG. 4 is generated. Note that at this stage, the user can set various parameters in the search program.

Next, as indicated by reference numeral 70, a screen prompting the user to detect a search path is displayed. When the user taps a detection start button 72 in response to this, the search path from the search start point A to the search end point B is detected using the generated search program, and the teaching point is also automatically generated at this stage.

After the detection of the search path is completed, a screen notifying the user to that effect is displayed as indicated by reference numeral 74. At this stage, the operation program for the robot including automatically generated teaching points has also been automatically generated. The user can check and edit the automatically generated operation program through a screen similar to that shown in FIG. 6.

In this way, in the second example, the UI 17 for generating the search program and the accompanying user operations are different from the first example, but the obtained search program itself can be substantially the same as in the first example. Therefore, the operation program obtained by executing the search program can also be substantially the same as in the first example.

According to the above-described examples, the operations of the user such as the teaching in generating the search program for generating the teaching point is significantly simplified by visual operation/input via the UI. Therefore, even an inexperienced user can generate a desired search program in a short time with simple operations, and furthermore, by executing the search program, appropriate teaching points (or an operation programs) can be automatically generated.

### REFERENCE SIGNS LIST

10 robot system
12 robot
14 robot controller
16 teaching operation panel
17 user interface
18 robot arm
20 workpiece
22 welding torch
24 sensor
26 welding power supply
28 PC
30 welding line
32 robot display area
34 timeline display area
36 menu display area
38, 40, 42, 60 icon
44 execution menu
46 program execution button
48 operation program
54a-54e teaching point
62, 66, 70, 74 wizard
64, 68 storage start button
72 detection start button

1. A program generation device configured to generate a program for controlling a robot having a sensor capable of detecting an operation line of a workpiece, the program generation device comprising:
a reception unit configured to receive an input of a search start position and a search end position of the operation line by the sensor, and an input of information relating to a search program including a detection condition of the sensor; and
a program generation unit configured to generate a search program for determining a teaching point corresponding to a position of the operation line, based on contents received by the reception unit.

2. The program generation device according to claim 1, wherein the program generation unit is configured to automatically generate an operation program including the teaching point corresponding to the position of the operation line, based on a result of execution of the search program.

3. The program generation device according to claim 1, wherein the input of the search start position and the search end position is executed by moving the robot by direct teaching or jog operation.

4. The program generation device according to claim 1, wherein searching of the operation line of by the sensor includes continuous scanning by the sensor along the operation line.

5. The program generation device according to claim 1, further comprising a display unit capable of displaying the program, wherein the display unit is configured to display at least one of: an icon including information relating to the search start position; an icon including information relating to the search end position; and an icon including information relating to an intermediate point between the search start position and the search end position.

6. The program generation device according to claim 1, further comprising a display unit capable of displaying the program, wherein the display unit is configured to display a wizard for setting at least one of the search start position, the search end position and the search program.

7. The program generation device according to claim 1, wherein the search program includes at least one of: information relating to a search range of the sensor; information relating to an output of the sensor; information relating to a path of the sensor; and information relating to an operation program generated based on a result of execution of the search program.

8. The program generation device according to claim 1, wherein the operation line includes a welding point of the workpiece or a sealing point of the workpiece.

9. A program generation device configured to generate a program for controlling a robot having a sensor capable of detecting an operation line of a workpiece, the program generation device comprising:
a display unit capable of displaying the program;
a display control unit to cause a wizard to be displayed on the display unit, the wizard being configured to receive an input of a search start position and a search end position of the operation line by the sensor, and an input of information relating to a search program including a detection condition of the sensor; and
a program generation unit configured to generate a search program for determining a teaching point corresponding to a position of the operation line, based on contents received by the wizard.
